(19) United States
(12) Patent Application Publication
(10) Pub. No.: US 2006/0206429 A1
(43) Pub. Date: Sep. 14, 2006

(54) Secure identification apparatus, system and method in a portable electronic device for financial and other secure systems

(76) Inventor: Pamela J. Martinez, Upper Marlboro, MD (US)

Correspondence Address: CONNOLLY BOVE LODGE & HUTZ LLP, SUITE 800, 1990 M STREET NW, WASHINGTON, DC, 20036-3425, US

(21) Appl. No.: 11/341,457

(22) Filed: Jan. 30, 2006

Related U.S. Application Data
(60) Provisional application No. 60/647,423, filed on Jan. 28, 2005.

(51) Int. Cl. G06Q 99/00; H04L 9/00; H04K 1/00

(52) U.S. Cl. 705/50

(57) ABSTRACT

The present invention is an apparatus, system and method for personal banking and other activities that require secure communications. The present invention utilizes biometrics and/or finger printing technology on a touch screen or window to allow customers to securely process information. The method of the device can be used for financial or other secure transactions (e.g., point-of-sales) from a cell phone or other portable apparatus by first identifying the customer, and exchanging information using the highest encryption technology available.

### BACKGROUND OF THE INVENTION

This present invention uses secure mobile communications technology and systems processing methods in the area of personal banking. More specifically, the present invention uses at least one of biometrics and finger printing technology on a portable touch screen device in combination with a pass code to securely process financial or other secure information. Similarly, the apparatus, system and method of the present invention can be used in any other financial or secure transactions.

The use of physical attributes—fingerprints, a voiceprint, or any of several other characteristics—to verify identity has great potential. Passwords and personal-identification numbers (PIN's) are fraught with problems. Biometrics offers solutions to these problems. Applications that are preparing to accept biometric data include computer networks, ATMs, cars, cellular phones, and dozens of other types of embedded systems.

Widespread acceptance of biometrics means use in areas that daily affect the lives of millions of people. By replacing PIN's, biometric techniques prevent the unauthorized access to or fraudulent use of ATM's, cellular phones, smart cards, desktop PC's, workstations, and computer networks. For financial transactions conducted via telephone and wire, biometrics can replace PIN's and passwords. In buildings and work areas, biometric techniques replace keys, badges, and readers. By replacing PIN's for transfers of funds to the cards, biometrics enhances the security of credit/debit-card (plastic-money) systems and prepaid telephone calling cards. Biometric techniques also provide security not previously envisioned for “cash” balances stored in such cards. For POS terminals, biometric techniques can replace a clerk's verification of a customer's signature.

As an example of the rapidly growing biometric technology, fingerprints offer an infallible means of personal identification and are rich in information content. It has been proven that fingerprints uniquely identify an individual based on their information content. In the fingerprint context, a large store of fingerprints exists in law enforcement offices around the country. Since fingerprints never change, a person need only be fingerprinted once to be in the system.

### BRIEF SUMMARY OF THE INVENTION

The present invention is an apparatus, system and method for personal banking and other activities that require secure communications. The present invention utilizes biometrics and/or finger printing technology on a touch screen or window to allow customers to securely process information. The method of the device can be used for financial or other secure transactions (e.g., point-of-sales) from a cell phone or other portable apparatus by first identifying the customer, and exchanging information using the highest encryption technology available.

The present invention creates a new, useful secure biometric identification process and financial system that uses wireless, cellular/digital and or infrared communications and electronic finger printing recognition technology. This technology will be referred to as TinyBank in what follows. Further, TinyBank includes a method called identification banking (iBanking). In particular, the iBanking method of the present invention provides an improvement in the way consumers manage financial accounts, exchange currency and transfer funds and handles other secure information.

The TinyBank technology of the present invention enables consumers to securely transfer funds, as well as communicate with financial institutions in ways that do not exist today. The present invention will allow financial institutions and network providers to identify customers and devices in a highly secure process. In addition, the method of the present invention will support overall better management of financial accounts and consumer attitudes toward financial management systems. Today, many consumers are challenged with successfully managing banking services where mistakes can result in costly fees and penalties. Using this technology, the average consumer will save on unnecessary banking fees by having portable, instant and accurate account information. The present invention can prevent some costly debit and credit transactions to the consumer. A combination of devices, computer programs and communication networks and methods are integrated, layered and designed in such a way that, with the latest encryption technology, the consumer can obtain instant and secure access to information.

The present invention provides a new and improved way of accessing financial networks for the purpose of gathering the financial status on checking, savings and other financial accounts. Other capabilities of the present invention include secure identification for purchases, balances and ftnds transfer.

### BRIEF DESCRIPTION OF THE DRAWING

FIG. 1 is a front view of a TinyBank apparatus in accordance with the present invention.

FIG. 2 is a side view of the TinyBank apparatus in accordance with the present invention.

FIG. 3 is a right-side view of the TinyBank apparatus in accordance with the present invention

FIG. 4 is a generic cell phone that may be integrated into the iBanking method of the present invention.

FIG. 5 shows an exemplary flow diagram of the first phase of the iBanking method directed to pass code verification and opening network communications.

FIG. 6 shows an exemplary flow diagram of the second phase of the iBanking method directed to customer validation.

FIG. 7 shows an exemplary flow diagram of the third phase of the iBanking method directed to CAPLET validation.

FIG. 8A and FIG. 8B show an exemplary flow diagram for a check account balance request in the present invention.

FIG. 9A and FIG. 9B show an exemplary flow diagram for a check payment transaction in the present invention.

FIG. 10A and FIG. 10B show an exemplary flow diagram for an electronic bill payment via a bank transaction in the present invention.

FIG. 11A and FIG. 11B show exemplary flow diagrams for a transfer of funds between accounts in one bank in the present invention.

FIG. 12A and FIG. 12B show exemplary flow diagrams for a transfer of funds between accounts in two bank in the present invention.

### DETAILED DESCRIPTION OF THE INVENTION

The present invention is an apparatus, system and method for accessing and secure identification to financial or other secure systems using a portable handheld apparatus. The apparatus and/or system of the present invention are referred to as TinyBank and the method is referred to as iBanking. The TinyBank technology of the present invention is designed to provide a secure, anywhere and anytime access to account information for personal data, secure transactions and/or small business financial accounts of any type. However, TinyBank technology is not limited to the banking industry, since it may also be useful in other financial venues, such as retirement accounts and other special purpose spending accounts. The iBanking method of the present invention combines the use of financial transactions processing and both the Secure Finger Identification Financial Information System (SFIFI) and the Secure Multipurpose Identification Financial Warehouse and Storage System technology (MIFS) for secure network access, identification, verification and processing.

The present invention provides a method for securely authenticating a client's identity using at least one of biometrics finger print image capturing and passes codes. The method of the present invention captures a finger print image on a display window/screen and combines this information with a pass code to create a secure authentication process for access to financial and other secure data.

In the apparatus of the present invention, the surface of a display window/screen is used to input/read and capture a thumb or finger print of a customer in order to provide access to financial and other secure networks. The apparatus of the present invention includes a keypad to enter local personal pass code to access secure networks and systems. The apparatus of the present invention may use finger printing technology (i.e., the thumb or any other finger) to identify customers, That is, by using a unique personal identifier, such as your fingerprint and a secret pass code/password, secure access is provided to financial and other secure networks.

The present invention may also utilize encryption technology to protect account information, pass codes/passwords, embedded smartcard data and finger print information. In addition, the present invention utilizes intelligent system matching so that different information may be accessed for different finger prints. The apparatus of the present invention may utilize a touch screen and biometrics to pass images through a portable and personal computing device. The finger print and/or smartcard data and pass codes inputted to the apparatus of the present invention are transmitted to clearinghouses that grant network access to secure data. The customer information is further compared and matched with a customer identification or key unique to the secure system. Only a complete match of the prescribed parameters will unlock the secure network and allow transmission of financial and other secure data.

In addition, data warehouses are maintained in front of or behind the Credit Card Backbone and financial networks. Finger prints are maintained in a secure highly encrypted relational or object oriented database. However, this security infrastructure is flexible and consists of: (1) PIN and Keys for network access; (2) PIN and Keys TinyBank to access all networks using “one-time pass code” technology. The apparatus and/or system of the present invention are capable of passing secure information through a series of electronic communication devices anywhere and anytime, providing that the network is available. These communications devices may use existing cellular/wireless and/or digital communications or Internet telephony or specially designed apparatus or systems to send and receive secure data anytime and anywhere.

Preferably, the network that the TinyBank apparatus and/or system connect relies on existing financial and other secure communications networks. Alternatively, a new and separate network, allowing two-way communications between device and a financial key-access repository could be used to support the TinyBank apparatus and/or system. Internet Access or other communications access is also applicable to the present invention.

The TinyBank network (TBN) of the present invention consists of 4 basic parts:

(1) Physical Device reader—used for input and output from and to the financial institution;

(2) radio, cellular, smartcard or other wireless communications with security and protocols used to connect to financial institution;

(3) a key repository with one time pass-code to permit communications; and

(4) a repository containing the finger and/or thumb print images and encrypted account information. Though a closed network is a possibility, it may prove to be unnecessary in some future development efforts.

The apparatus of the present invention provides two-way communications between a customer and financial institutions and transmits keys; a CAPLET of the finger print; and encrypted account information for complete identification and verification. In addition, the customer may perform transactions via the Internet using encrypted communications and the keyboard of the present invention with an integrated finger print reader or a finger print reader that is separate from the apparatus. The finger print reader can be interfaced to the apparatus through any of the popular device interfaces such as USB, RS-232, Bluetooth, radio wave, microwave, smartcard and infrared technologies. These interfaces are common to personal computers, handheld personal devices or cellular, digital and wireless phones which may be used to implement the apparatus and/or system of the present invention.

With the apparatus of the present invention, customers may securely check balances, transfer funds between accounts, and/or check pending items last processed items on specific accounts from any location. The TinyBank apparatus provides abbreviated personal financial account information, for example; account balances on multiple accounts, cleared transactions, pending transactions and permits transferring of funds between accounts.

In addition, the TinyBank apparatus of the present invention provides the ability to transfer funds from disparate systems and networks, using bank routing numbers and customer account numbers, from portable or handheld devices. Further, the TinyBank apparatus and/or system eliminates the need for paper transactions, in nearly all customer transactions. The TinyBank apparatus and/or system of the present invention provides the capability to access most common financial networks such as, but not limited to: Visa, MasterCard, American Express, Discover, Most, Plus and NYSE systems.

The apparatus and/or system of the present invention includes integrated circuits and/or the method defines onboard programs designed for each network and system required. The apparatus includes a display window/screen that captures the finger print data and forwards it to a secure service for verification.

Moreover, the present invention provides access to a secure network of communication devices, comprising a personal device, remote services and application programs. This access provides the customer with convenient, portable, mobile, secure, and simple banking transactions and information on any financial accounts. In addition, hotkeys may be programmed into the apparatus and/or system in order to shorten operation commands and input requirements.

An architectural description of the present invention is provided below. The TinyBank apparatus and/or system of the present invention includes a portable or handheld apparatus that may further include biometric technology for Finger Print identification; Vector Segment Technology or similar advanced biometrics technologies capable of uniquely identifying and or distinguishing a person with the lowest rate of false positives.; Java 2 Platform, Standard Edition (J2SE™) for Embedded or Java 2 Platform, Micro Edition (J2ME™); a Connected Limited Device Configuration Version 1.1 and/or Smartcard embedded (micro or nano) technology. In addition, the functions of the TinyBank apparatus, portable or handheld device include, but are not limited to: being JWTI compliant to support the underlining technologies; creating digital hash from Finger Print Image or SmartData; operating in a Secured TinyBank Network Environment; calling crypto-processes and storing customer identification (Customer_ID) and handheld device identification (HHD_ID) in a local database; enabling RF/Wireless/USB/Smartcard communication for PaySecure Integration. However, the apparatus and/or system of the present invention does not store Finger Print Image local to handheld or mobile device.

In addition, the apparatus and/or system of the present invention further comprise Secure Finger Identification Financial Information (SFIFI) Servers. In addition, the present invention includes an environment with Front-End Gateway Application Servers and Authentication. Furthermore, the environment of the present invention includes, but is not limited to: Java 2 Enterprise, Edition (J2EE™) or uses of other High-level languages. The functions of these servers include but are not limited to: (1) a Front-End Gateway Server designed to support grid computing (e.g., multiple servers acting as one server for performance and redundancy); setting up secure communication; calling SMIFS servers to Match Customer_ID to Finger Prints supplied from handheld devices; the SFIFI servers handle all HHD requests on the Front-end; allowing only servers to handle request and respond to a core server; and creating CAPLETs (i.e., Customer_ID, and FingerPrint) and transmitting resulting information.

Further, the apparatus and/or system of the present invention further comprise an SFIFI Security Network (e.g., TinyBank Network) for HHD-to-SFIFI-to-SMIFS communications. That is, the apparatus and system of the present invention has a Secure Communications Environment that includes, but is not limited to: Java Crypto Environment (JCE) within the Java 2 SDK, v 1.4; Security and Trust Services API for J2ME™; SHA2 or other secure hashing Algorithm or Enhanced Security Environment from the HHD. The functions of the apparatus and/or system further include, but are not limited to: using crypto-profiles to encrypt Finger Prints and Customer_ID information; encrypting all transmissions using 256-2048 bytes; creating encryption keys for all images stored using the highest level of encryption supported in Java for transmissions wherein performance is not degraded; establishing a Private Network Secure Session (peer to peer) with HHD and TBN; and using HHD_ID, Customer_ID and Image_ID (TripleID) to complete transaction.

Further, the apparatus and/or system of the present invention further comprise a SFIFI servers Database for HHD_IDs. In particular, the present invention includes a simple storage environment for storing a database that includes, but is not limited to Oracle. The function of the present invention further comprises an obfuscating processes and storing encrypted HHD_IDs.

Further, the apparatus and/or system of the present invention further comprise a Secure Multi-Identification Financial System (SMIFS) Server. In particular, the present invention comprise Backend Servers that form the TinyBank Core and has a proposed environment that includes, but is not limited to: Java 2 Enterprise Edition (J2EE) or other High-level Languages. In addition the functions of the apparatus and/or system include, but are not limited to: providing a Core Application Server (J2EE Server) containing all application components for TinyBank processing; processing request from Desktop clients (i.e., financial institutions) to create TinyBank Records and storing encrypted finger print images in a database; allowing only servers to handle request and respond to a banks front-end; and making JDBC thick and other secure connections to a Master Database.

Furthermore, the apparatus and/or system of the present invention further comprise a TinyBank Financial Institution Client. In particular, the present invention includes, but is not limited to: a desktop environment with Java Virtual Machine (JVM) Integration or Web Interface using Secure Hyper Text Transfer Protocol (HTTPS). In addition the functions of the present invention include, but are not limited to: an input interface; extension of TinyBank Core Application; requesting creation of TinyBank Master Records; and requesting creation of TinyBank_unique identification numbers.

Moreover, the apparatus and/or system of the present invention further comprise SMIFS Database (i.e., a core application). In particular, the present invention includes, but is not limited to: a storage environment with a relational or Object Oriented database and extensible markup language (XML) for interoperability and standardization with financial institutions and other industries where this technology may be employed; a JDBC Optional Package for Java 2 Micro Edition (J2ME) and a Connected Device Configuration (CDC) Foundation Profile. In addition, the functions of the present application includes, but is not limited to: supporting transactional requests; storing encrypted finger print images (digital hash) or equivalent; maintaining a Master Database that Stores TinyBank Customer Records; implementing a database capable of managing large chunks of records; and storing a database (e.g., Oracle).

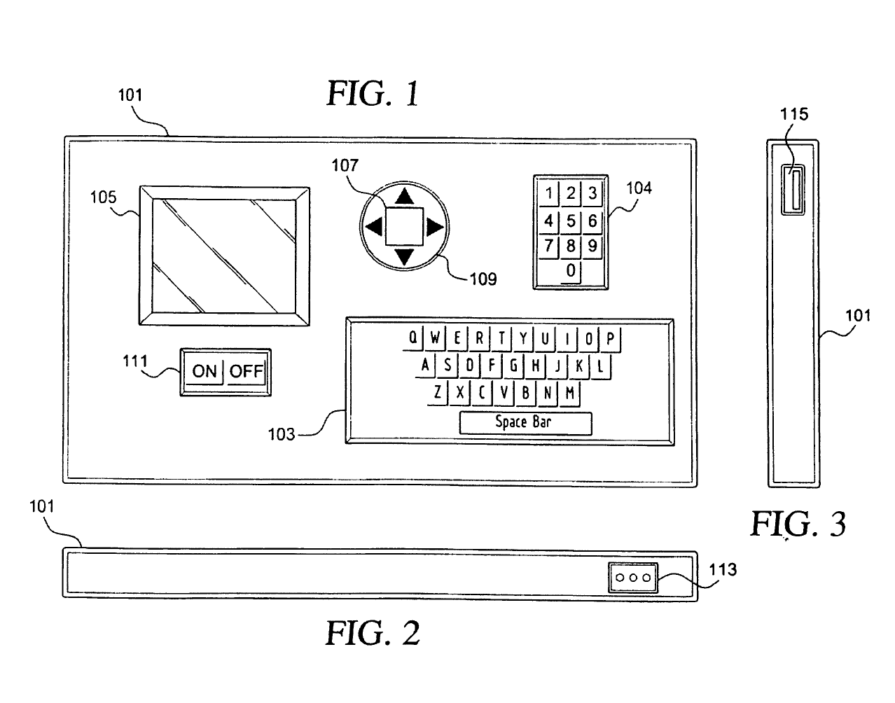

FIG. 1 is a front view of an exemplary TinyBank apparatus in accordance with the present invention. In particular, FIG. 1 shows an apparatus 101, for use with the iBanking process, comprising a numeric keypad 103, an alphabetic keypad 104, display window 105 and a combined input window 107 for thumb print recognition to support secure transactions and cursor control pad 109 for navigating the display window 105. Of course, the numeric keypad 103 and alphabetic keypad 104 may be replaced by a single alphanumeric keypad. The apparatus of the present invention allows at least two levels of password key protection (e.g., finger print and alphanumeric password). Alternatives to fingerprinting as biometric data include, but are not limited to palm prints and retinal scans. In addition, the present invention contains embedded encryption algorithms/programs that load application and allows encryption of finger print and other data transmitted by the apparatus in order to maintain the security of the information.

Preferably, the display window 105 or input window 107 of the present invention is at least large enough to accommodate the average human finger or thumb. Preferably, either the display window 105 or the input window 107 can provide finger print recognition input data. More preferably, the display window 105 and input window 107 are combined in one window/device. More preferably, the dimension of the display window/input window is at least approximately 2 inches by 2 inches.

Preferably the cursor control moves cursor around on the display window screen. Preferably, the alphabetic, numeric and/or alphanumeric keypad is used to input pass codes/passwords into the apparatus.

FIG. 2 is a side view of the TinyBank apparatus 101 in accordance with the present invention. In particular, FIG. 2 shows an exemplary first communication port 113 used to communicate data to/from the apparatus 101. Exemplary approaches that may be used for the first communications port 113 include, but are not limited to, wired (e.g., cable, fiber optics and telephone lines), wireless (e.g., radio waves, microwaves, infrared and optical means (e.g., lasers, light-emitting diodes)) and other well known voice and/or data communication means to exchange information with secure networks and non-secure networks with encryption (e.g., the Internet).

FIG. 3 is an exemplary bottom view of the TinyBank apparatus in accordance with the present invention. In particular, FIG. 3 shows a second communication port 115 used to support, for example, interface connectivity between the apparatus 101 and other devices and/or power sources. Example interfaces that may be used for the second communication port 115 include, but are not limited to, USB, RS-232, IEEE-1394, Bluetooth and other well known device interface standards. Example devices that may be interface to include power sources, other TinyBank apparatus, power sources, radio telephones, personal digital assistants, personal computers and other well known personal communication devices.

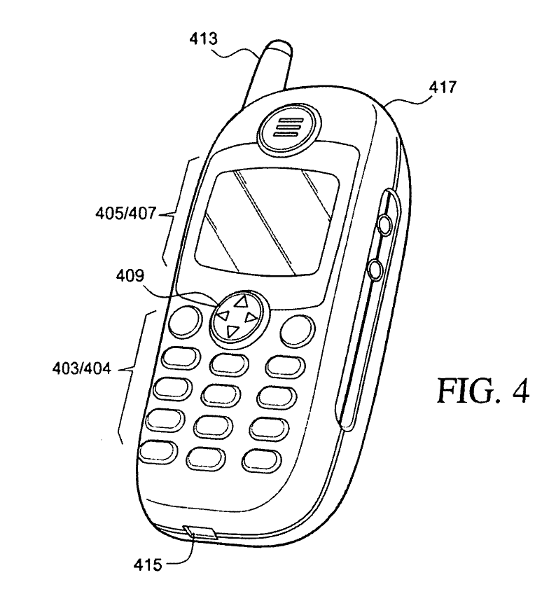

FIG. 4 shows an exemplary input apparatus or device (i.e., a generic cell phone) that may be integrated into the iBanking method of the present invention. In particular, the iBanking method can integrated into the generic cell phone 117 shown in FIG. 4 and provide the same functionality as the apparatus of FIG. 1 when the generic cell phone further comprises a display/input screen modified for Finger Print recognition and includes an embedded software application for secure network access. Specifically, as shown in FIG. 4, the generic cell phone 117 may provide an alphanumeric keypad 103/104; and display/input window 105/107; cursor control `09; a first communication port 113; and a second communication port 115, analogous to those provided by the TinyBank apparatus 101 of FIG. 1. Alternatively, the iBanking method of the present invention can also be integrated into a portable computer (PC), personal digital assistant (PDA), embedded smart technology using Nano technology, or other well known portable devices comprising an alphanumeric keypad/keyboard, display/input window and cursor control.

The TinyBank method for client setup of the present invention is a desktop (Client) for accessing a financial institution or other secure environment. The method at least comprises signing up customers for TinyBank Services; providing a list of servers and compatible list of Java Technology Wireless Industry (JTWI) compliant Handheld devices (HHD) by a Customer Representative (CR); opening a desktop application in to TinyBank Network (TBN) via a Secure Web Interface; completing a TinyBank Customer Application with a Banks Customer_ID; and using an Online Finger Print Device to accept ImageTinyBank Online device (e.g., a server).

In addition, the method of the present invention at least includes securing Secure Multipurpose Information Financial System. Further, the TinyBank Online application REGISTERS, ENCRYPTS and STORES image and Customer_ID and Creates TinyBank_ID to a Secure Multipurpose Information Financial Systems (SMIFS) database; verifying SMIFS backend setup; matching biometric images (e.g., digital equivalent) or smartcard data; verifying Customer_ID with Unique TinyBank data and banks records; identifying the relation between TinyBank_ID record to Bank accounts; and providing a predetermined access level to TinyBank.

Furthermore, the method of the present invention at least comprises a TinyBank Application Installation and Registration for the apparatus or portable handheld device (HHD) of the present invention. The present invention includes, but is not limited to: connecting a customer to the TinyBank Network (TBN); entering/inputting the Unique Code/Pass Code of the customer; confirming a phone number for validation; registering the apparatus of handheld device identification number (HHD_ID); flashing/sending the TinyBank Code to the HHD; loading the Encryption Code; reading the HHD identification number; encrypting and storing in a mini-table on the apparatus, handheld device or system; and testing, storing and validating finger print data in an Authentication and Network Session.

Moreover, the method of the present invention at least comprises a SFIFI server that authenticates a first phase HHD_ID with SFIFI Local Database during a first phase of network access. The present invention includes, but is not limited to: generating The HHD_ID at the Financial Institution during Account_Creation or during application activation using /Service Activation Process; and sending biometrics data or embedded smartcard data from the HHD to the SFIFI and server.

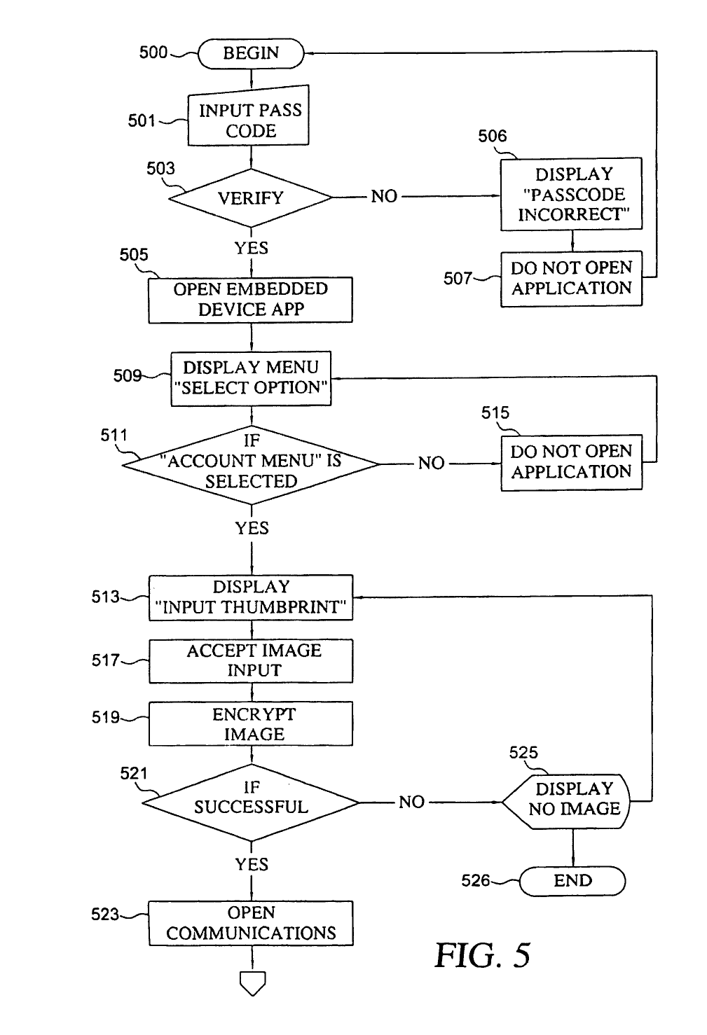

FIG. 5 to FIG. 7 show flow charts for the method of matching finger prints and account information in a TinyBank apparatus and/or system. In particular, FIG. 5 to FIG. 7 show flow charts for the matching process that matches account information and images to provide access to personal financial data or other secure data.

FIG. 5 shows an exemplary flow diagram of the first phase of the iBanking method directed to verifying pass codes and opening network communications. As shown in FIG. 5, in step 501 of the iBanking method the input pass code/password is manually input for local verification at the TinyBank apparatus. Step 503 of FIG. 5 checks to verify the pass code/password that was inputted is valid. If the pass code/password is determined to be valid in step 503, the embedded device application is opened in step 505. Alternatively, if the pass code/password is determined to be invalid in step 503, the message “PASSCODE INCORRECT” is shown in the display window of the TinyBank apparatus in step 506, no embedded device application is opened in step 507, and one returns to the beginning of the routine in step 509.

After the embedded device application is opened in step 505, a display menu is provided in the display window of the apparatus with a “SELECT OPTION” in step 509. In step 511 of FIG. 5, a determination is made of whether the “ACCOUNT MENU” was selected. If the “ACCOUNT MENU” is selected, a request for “INPUT THUMBPRINT” is displayed in the display window of the TinyBank apparatus in step 513 of FIG. 5. Alternatively, if the “ACCOUNT MENU” is not selected, no application is opened in step 515 and the routine returns to displaying “SELECT OPTION” of step 509.

After the embedded device application for the “INPUT THUMBPRINT” is opened in step 513, the image input is accepted by the TinyBank apparatus in step 517 of FIG. 5. In step 519 of FIG. 5, the accepted image is encrypted in step 519 using, for example, Secure Hash Algorithm (SHA) (e.g., SHA2 (SHA256, SHA384, SHA512)) or other variant of the SHA. The method of the present invention is not limited to the SHA algorithm. The TinyBank application can make use of existing biometrics algorithms that exploit unique and secure methods. The TinyBank application shall be flexible in its design and support multiple secure hashing and/or digital encoding methods for the use to transmissions, verifications, and importantly identifications. As newer standards are developed the present invention will make available these enhancements to embody the most secure options for use.

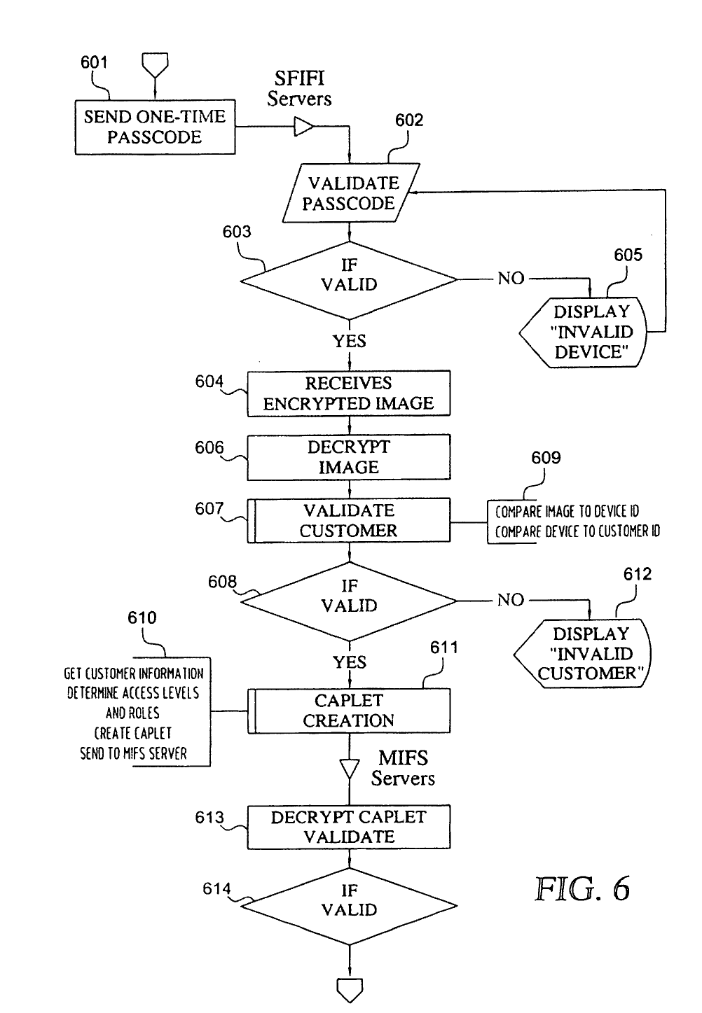

In step 521 of FIG. 5, a determination is made of whether the image encryption of step 519 was successful. If the encryption of step 519 is not successful, no image is displayed in the display window of the TinyBank apparatus in step 525 and the routine is ended in step 526. Alternatively, if the encryption of step 519 was successful, communications is opened with network servers in step 523. The iBanking method continues as shown in FIG. 6, as discussed below.

FIG. 6 shows an exemplary flow diagram of the second phase of the iBanking method directed to customer validation. As shown in FIG. 6, in step 601 of the iBanking process, a “one-time pass code” is sent to Secure Finger Identification Financial Information (SFIFI) system servers in order to obtain network access. In step 602 of FIG. 6, it is determined whether the “one-time pass code” was valid. If the pass code/password is determined to be valid in step 603, the encrypted image is sent/received in step 604. Alternatively, if the pass code/password is determined to be invalid in step 603, the message “IMAGE OR DEVICE INVALID” is shown in the display window of the TinyBank apparatus in step 605 and the routine returns to step 602 to attempt to validate a pass code/password.

In step 606 of FIG. 6, the received image is decrypted. Step 607 of FIG. 6 is directed to further validating the customer. In particular, steps toward validating the customer include routines that compare the image to the device identification of the TinyBank apparatus and compare the device identification number to the customer identification number.

In step 608 of FIG. 6, it is determined whether the customer identification is valid. If the customer identification is determined to be valid in step 608, a CAPLET is created in step 611. Alternatively, if the customer identification is determined to be invalid in step 608, the message “INVALID CUSTOMER” is shown in the display window of the TinyBank apparatus in step 612 and the routine returns to step 607 to attempt to validate a customer.

A CAPLET is created in step 611 of FIG. 6. A CAPLET is a combination of a thumb/finger print image and account information created after network validation. Further details of the routine for CAPLET creation are defined in step 610 of FIG. 6. In particular, the CAPLET creation of step 611 further comprises the steps of: (1) getting customer information; (2) determining access levels and roles; (3) creating the CAPLET; and (4) sending the CAPLET to a Secure Multipurpose identification financial warehouse storage system (SMIFS). In addition, a wrapper (i.e., an encrypted image and customer id and/or Account No.) is created. The SMIFS repository server unwraps/decrypts the CAPLET in step 613 of FIG. 6. A next phase of the iBanking methods directed to the repository SMIFS server validating the CAPLET data (i.e., image and customer identification) is discussed below.

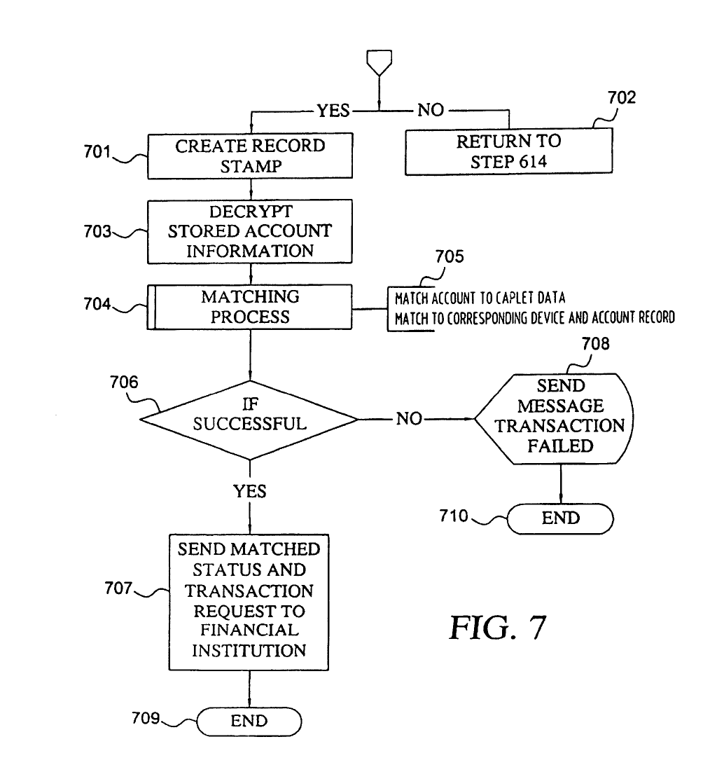

FIG. 7 shows an exemplary flow diagram of the third phase of the iBanking method directed to CAPLET validation. In step 614 of FIG. 6, it was determined whether the CAPLET is valid. If the CAPLET is determined to be valid in step 614, a record stamp is created in step 701. Alternatively, if the CAPLET is determined to be invalid in step 614, the message “CAPLET INVALID” is shown in the display window of the TinyBank apparatus in step 702 and the routine returns to step 614 of FIG. 6 in an attempt to validate the CAPLET.

In step 703 of FIG. 7, the stored account information is decrypted. Step 704 of FIG. 7 is directed to a matching method routine. In particular, further steps toward the matching method include routines for: (1) matching account record information to the CAPLET data; and (2) matching corresponding device information to the account record information of the TinyBank apparatus.

In step 706 of FIG. 7, it is determined whether the matching process of step 704 was successful. If the matching process is determined to be successful in step 706, the matched status and a transaction request is sent to the financial institution in step 707 and the iBanking process ends at step 709. Alternatively, if the matching process is determined to be unsuccessful in step 704, the message “TRANSACTION FAILED” is shown in the display window of the TinyBank apparatus in step 708 and the routine ends in step 710.

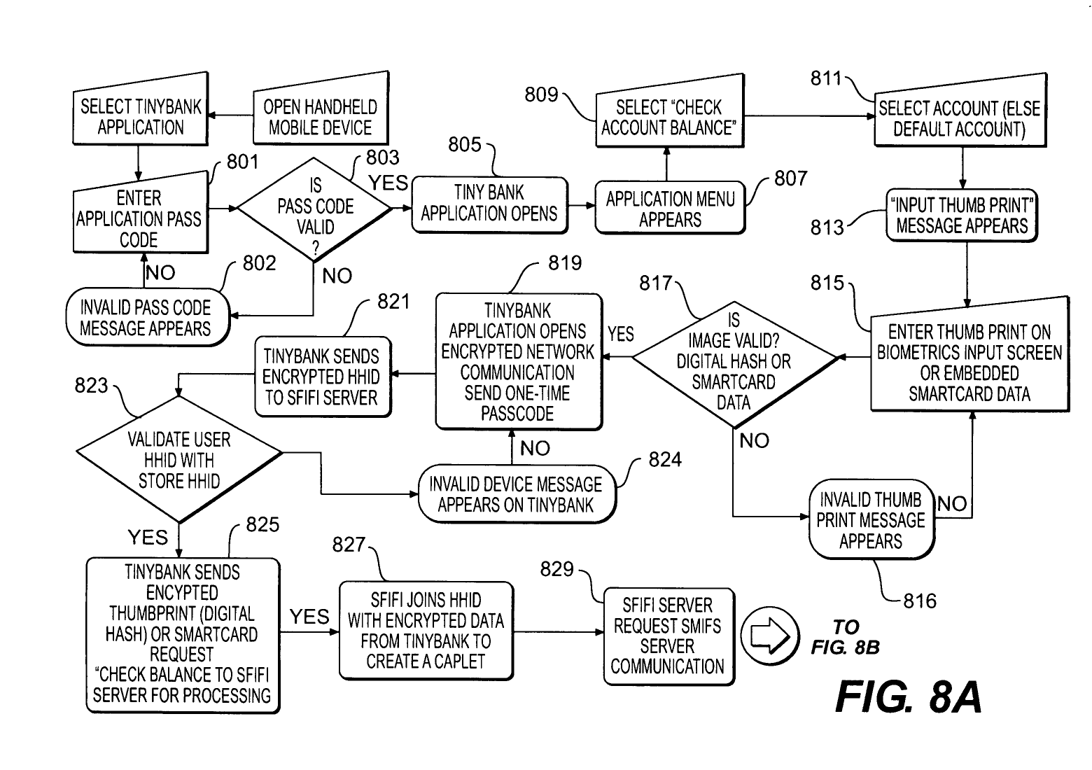

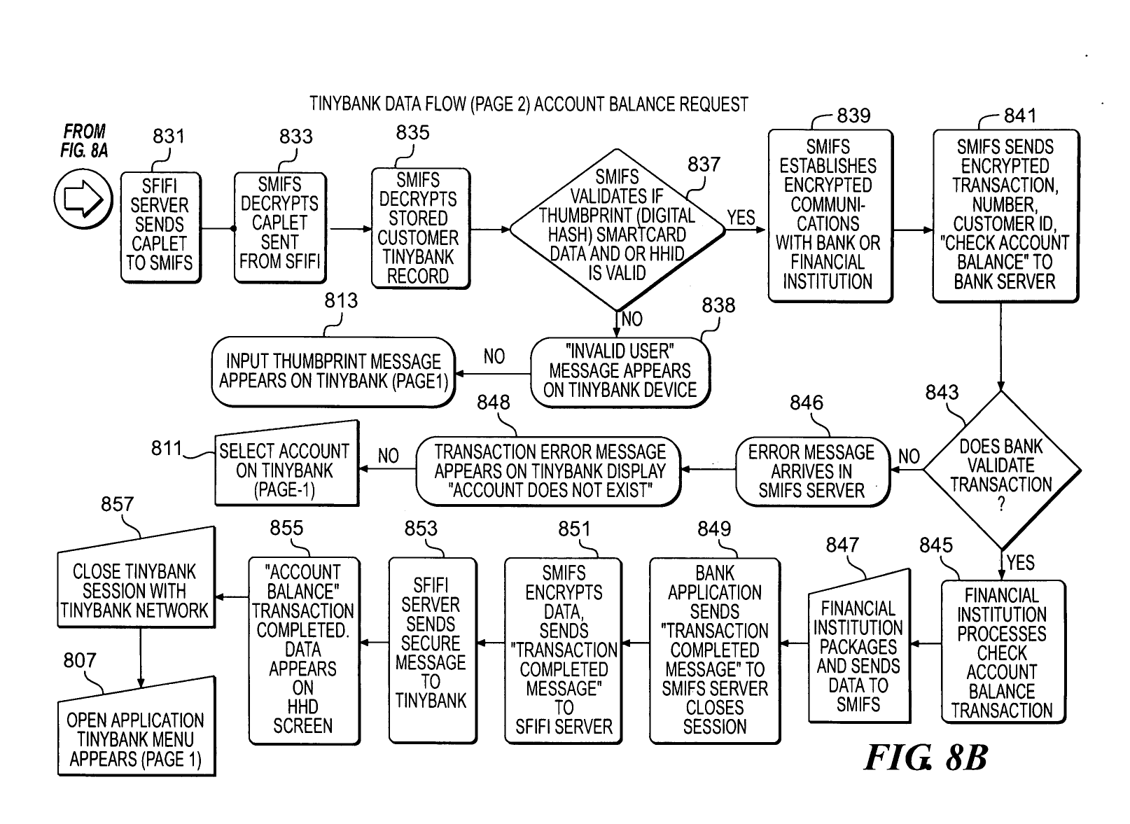

FIG. 8A to FIG. 12B show additional exemplary flow charts for the processing of different menu options for a customer using in a TinyBank apparatus and/or system. In particular, FIG. 8A and FIG. 8B show an exemplary flow diagram for a check account balance request in the present invention. Step 801 of FIG. 8A involves entering/inputting the application pass code/password. In step 803, it is determined whether the pass code/pass word was valid. If the pass code/password is determined to be invalid in step 803, an “INVALID PASS CODE” message is shown in the display window of the TinyBank apparatus and the method returns to step 801 to await a pass code/password input. If the pass code/password is determined to be valid in step 803, a TinyBank application opens on the TinyBank apparatus in step 805 and an Application Menu opens on the display on the display window in step 807.

In step 809 of FIG. 8A, the “CHECK ACCOUNT BALANCE” option is selected from the Application Menu and an Account Menu appears. In step 811 an account number is selected from an Account Menu or a default account number is selected. In FIG. 8A, step 813 provides an “INPUT THUMB PRINT” message on the display window of the TinyBank apparatus. In step 815, the customer enters at least one of a thumb or finger print on the input screen, or embedded SmartCard data into the TinyBank apparatus. In step 817, it is determined whether the thumb print or finger print image was valid. If the thumb print or finger print is determined to be invalid in step 817, an “INVALID THUMB PRINT” message is shown in the display window of the TinyBank apparatus in step 816 and the method returns to step 815 to await another input. If the thumb print or finger print image is determined to be valid in step 817, a TinyBank Application opens an Encrypted Network Communication and sends a One-Time Pass code in step 819. Step 821 sends an encrypted portable or handheld device identification (HHID) to the Secure Finger Identification Financial Information System (SFIFI) Server.

In step 823, it is determined whether the portable or handheld device identification or other data entered was valid. If the portable or handheld device identification or other data entered is determined to be invalid in step 823, an “INVALID DEVICE” message is shown in the display window of the TinyBank apparatus in step 824 and the method returns to step 819 to await another input. If the portable or handheld device identification or other data entered is determined to be valid in step 823, the TinyBank sends the encrypted thumbprint (digital hash) or SmartCard request to “CHECK BALANCE” to the SFIFI server for processing in step 825.

In step 827 of FIG. 8A, the SFIFI joins the HHID with encrypted data from TinyBank to create a CAPLET. The SFIFI Server requests the Secure Mulitpurpose Identification Financial Warehouse Storage System (SMIFS) Server communication in step 829. In step 830, at least one of the finger print, thumb print, smartcard data and handheld device identification is encrypted. In step 831 of FIG. 8B, the SFIFI Server sends the CAPLET to the SMIFS Server. The SMIFS Server decrypts the CAPLET in step 833. In step 835, the SMIFS Server decrypts stored TinyBank customer records.

In step 837 of FIG. 8B, the SMIFS Server determines whether the finger print, thumb print, Smartcard Data or handheld device identification is valid. If determined as invalid in step 837, an “INVALID USER” message is shown in the display window of the TinyBank apparatus in step 838 and the method returns to step 813 to await another input. If determined as valid in step 823, the SMIFS establishes encrypted communications with a bank, financial institution or other secure location in step 839. In step 841, the SMIFS sends encrypted transaction number, customer identification and “CHECK ACCOUNT BALANCE” request to the BANK Server.

In step 843 of FIG. 8B, the Bank Server determines whether the encrypted transaction number, customer identification is valid. If determined as invalid in step 843, an error message is sent to the SMIFS Sever in step 846; a “TRANSACTION ERROR” message appears in the display window of the TinyBank apparatus in step 848; and the method returns to step 811 to await another input. If determined as valid in step 843, the bank, financial institution or other secure location processes the “CHECK ACCOUNT BALANCE” transaction in step 845.

In step 847 of FIG. 8B, the bank, financial institution or other secure location packages and sends data to the SMIFS. The bank application sends a “TRANSACTION COMPLETED” message to the SMIFS Server and closes the session in step 849. In step 851, the SMIFS encrypts data and sends a “TRANSACTION COMPLETED” message to the SFIFI Server. The SFIFI Server sends a secure message to the TinyBank apparatus and/or system is step 853. In step 855, the “ACCOUNT BALANCE” transaction is completed and account balance data appears on the display window of the TinyBank apparatus. The communication session with the TinyBank Network is closed in step 857 and the application returns to the TinyBank Application Menu of step 807 of FIG. 8A.

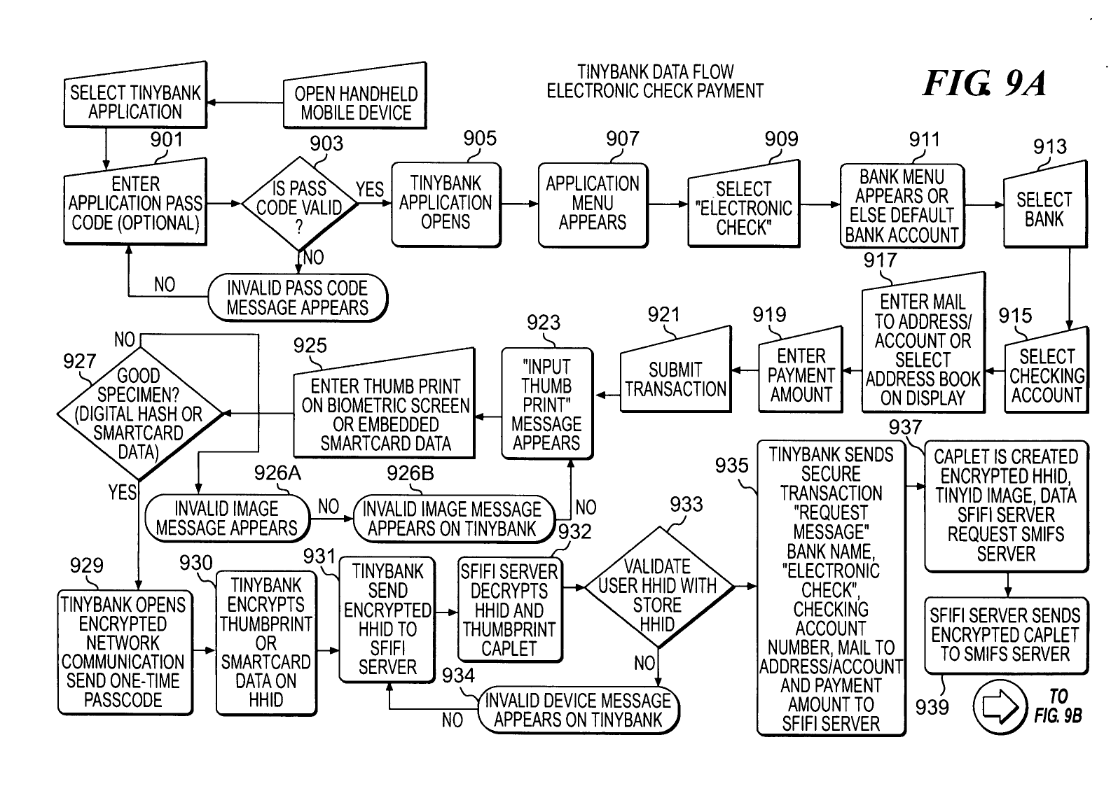

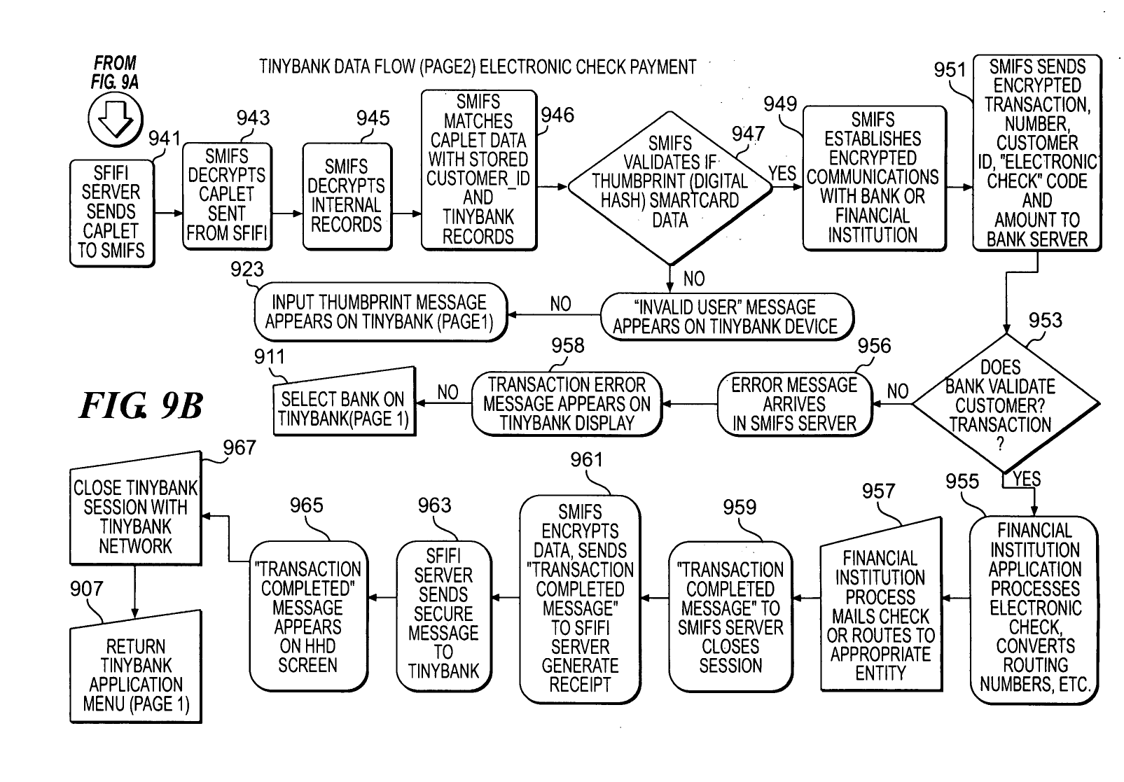

FIG. 9A and FIG. 9B show an exemplary flow diagram for a check payment transaction in the present invention. Step 901 of FIG. 9A involves entering/inputting the application pass code/password. In step 903, it is determined whether the pass code/pass word was valid. If the pass code/password is determined to be invalid in step 903, an “INVALID PASS CODE” message is shown in the display window of the TinyBank apparatus and the method returns to step 901 to await a pass code/password input. If the pass code/password is determined to be valid in step 903, a TinyBank application opens on the TinyBank apparatus in step 905 and an Application Menu opens on the display on the display window in step 907.

In step 909 of FIG. 9A, the “ELECTRONIC CHECK” option is selected from the Application Menu and a Bank Menu appears in step 911 or a default bank is selected. Step 913 selects a bank from the Bank Menu. In step 915, a checking account is selected. Entering mail to address/account or selecting address book on the display of the TinyBank apparatus occurs in step 917. In step 919, a payment amount is entered into the TinyBank apparatus. The transaction is submitted to the bank in step 921.

In FIG. 9A, step 923 provides an “INPUT THUMB PRINT” message on the display window of the TinyBank apparatus. In step 925, the customer enters at least one of a thumb or finger print on the input screen, or embedded SmartCard data into the TinyBank apparatus. In step 927, it is determined whether the thumb print or finger print image or other data entered was valid. If the thumb print or finger print or other data entered is determined to be invalid in step 827, an “INVALID THUMB PRINT/IMAGE” message is shown in the display window of the TinyBank apparatus in step 926 and the method returns to step 923 to await another input. If the thumb print or finger print image or other data entered is determined to be valid in step 927, a TinyBank Application opens an Encrypted Network Communication and sends a One-Time Passcode in step 929. In step 930, at least one of the finger print, thumb print, smartcard data and handheld device identification is encrypted. Step 931 sends the encrypted data to the Secure Finger Identification Financial Information System (SFIFI) Server. In step 932 of FIG. 9A, the SFIFI Server decrypts the encrypted data.

In step 933, it is determined whether the portable or handheld device identification was valid. If the portable or handheld device identification is determined to be invalid in step 933, an “INVALID DEVICE” message is shown in the display window of the TinyBank apparatus in step 934 and the method returns to step 931 to await another input. If the portable or handheld device identification is determined to be valid in step 933, the TinyBank sends a secure/encrypted transaction request message with bank name for an “ELECTRONIC CHECK” with a checking account number, mail to address/account and payment amount to the SFIFI server for processing in step 935.

In step 937 of FIG. 9A, the SFIFI joins the HHID, TinyBank ID (TINYID), and image data encrypted from TinyBank to create a CAPLET. The SFIFI Server requests the Secure Mulitpurpose Identification Financial Warehouse Storage System (SMIFS) Server communication in step 939.

In step 941 of FIG. 9B, the SFIFI Server sends the CAPLET to the SMIFS Server. The SMIFS Server decrypts the CAPLET in step 943. In step 945, the SMIFS Server decrypts stored TinyBank internal and customer records. The SMIFS matches CAPLET data with stored customer identification and TinyBank internal records in step 946.

In step 947 of FIG. 9B, the SMIFS Server determines whether the finger print, thumb print, Smartcard Data or handheld device identification is valid. If determined as invalid in step 947, an “INVALID USER” message is shown in the display window of the TinyBank apparatus in step 948 and the method returns to step 923 to await another input. If determined as valid in step 947, the SMIFS establishes encrypted communications with a bank, financial institution or other secure location in step 949. In step 951, the SMIFS sends encrypted transaction number, customer identification and “ELECTRONIC CHECK” request and an amount to the BANK Server.

In step 953 of FIG. 9B, the Bank Server determines whether the encrypted transaction number, customer identification is valid. If determined as invalid in step 953, an error message is sent to the SMIFS Sever in step 956; a “TRANSACTION ERROR” message appears in the display window of the TinyBank apparatus in step 958; and the method returns to step 911 to await another input. If determined as valid in step 953, the bank, financial institution or other secure location processes the “ELECTRONIC CHECK” transaction in step 955.

In step 957 of FIG. 9B, the bank, financial institution or other secure location processes and mails or routes checks to the appropriate entity and sends data to the SMIFS. The bank application sends a “TRANSACTION COMPLETED” message to the SMIFS Server and closes the session in step 959. In step 961, the SMIFS encrypts data and sends a “TRANSACTION COMPLETED” message to the SFIFI Server and generates a receipt. The SFIFI Server sends a secure/encrypted message to the TinyBank apparatus and/or system is step 963. In step 965, the “TRANSACTION COMPLETED” message appears on the display window of the TinyBank apparatus. The communication session with the TinyBank Network is closed in step 967 and the application returns to the TinyBank Application Menu of step 907 of FIG. 9A.

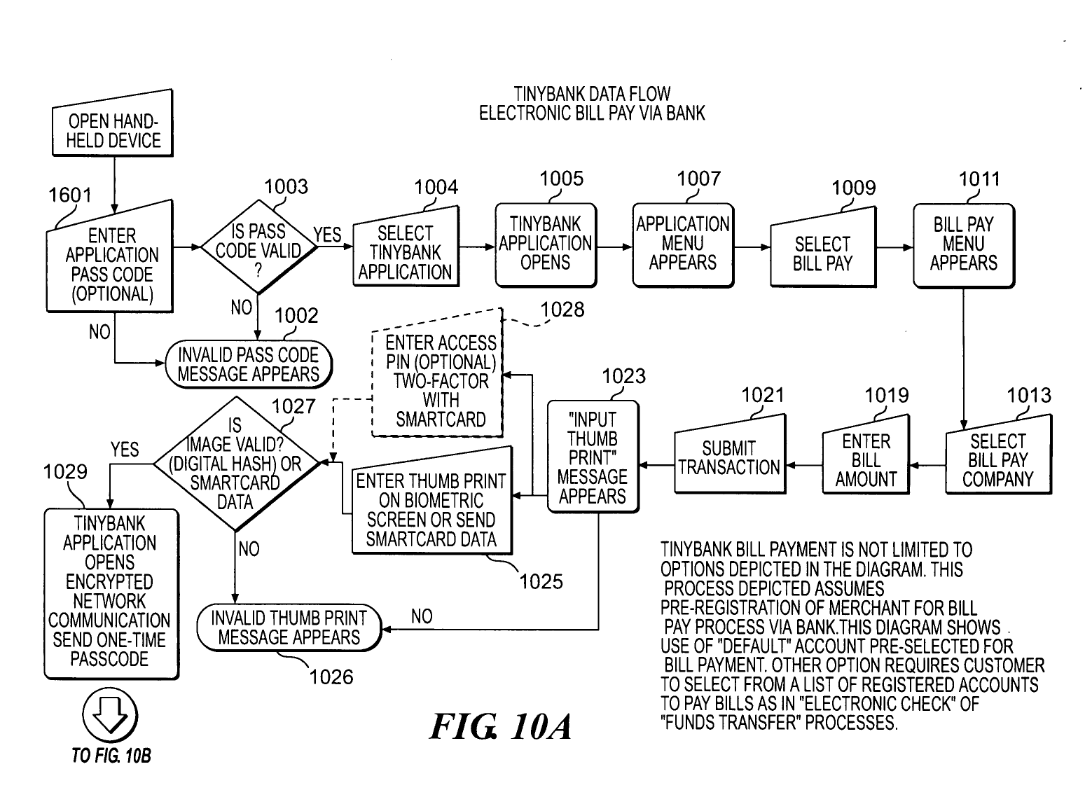

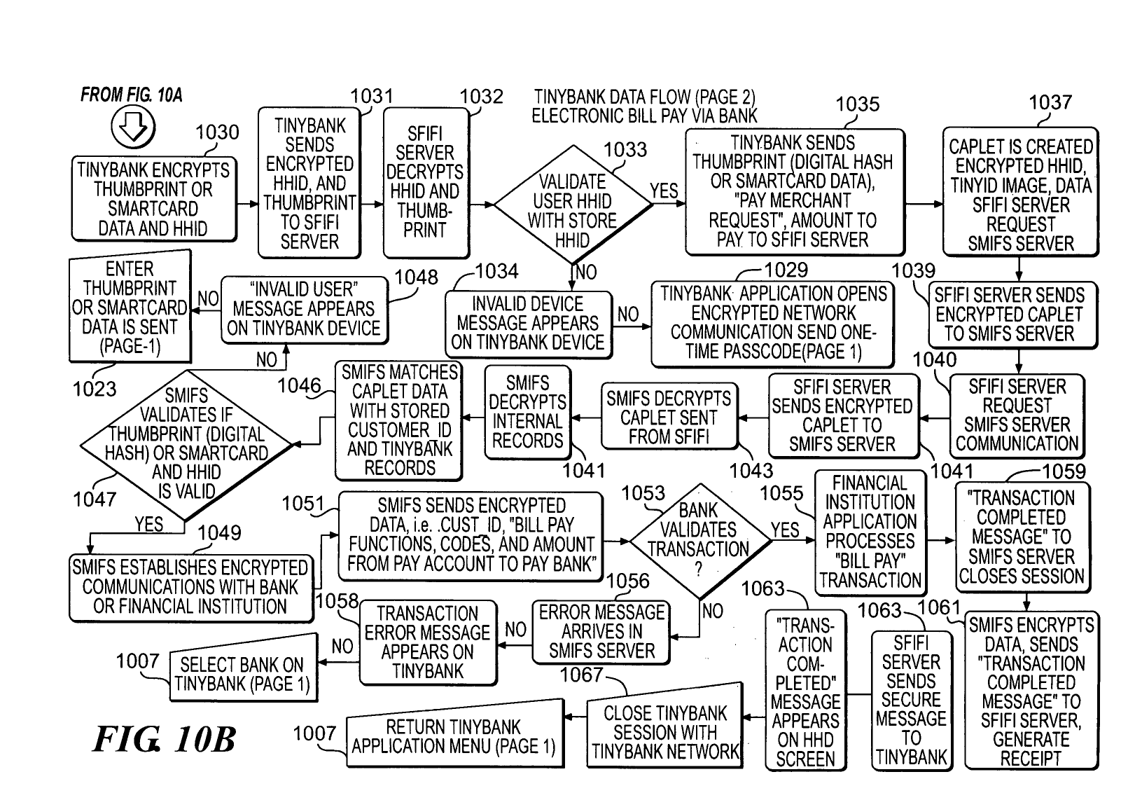

FIG. 10A and FIG. 10B show an exemplary flow diagram for an electronic bill payment via a bank transaction in the present invention. Step 1001 of FIG. 10A involves entering/inputting the application pass code/password. In step 1003, it is determined whether the pass code/pass word was valid. If the pass code/password is determined to be invalid in step 1003, an “INVALID PASS CODE” message is shown in the display window of the TinyBank apparatus and the method returns to step 1001 to await a pass code/password input. If the pass code/password is determined to be valid in step 1003, a TinyBank application opens on the TinyBank apparatus in step 1005 and an Application Menu opens on the display of the display window in step 1007.

In step 1009 of FIG. 10A, the “SELECT BILL PAY” option is selected from the Application Menu and a Bill Pay Menu appears in step 1011. Step 1013 selects a company to pay from the Bill Pay Menu. In step 1019, a payment amount is entered into the TinyBank apparatus. The transaction is submitted to the bank in step 1021.

In FIG. 10A, step 1023 provides an “INPUT THUMB PRINT” message on the display window of the TinyBank apparatus. In step 1025, the customer enters at least one of a thumb or finger print on the input screen, or embedded SmartCard data into the TinyBank apparatus. Alternatively, one may enter an optional access PIN and TWO-Factor with Smartcard in step 1028. In step 1027, it is determined whether the thumb print, finger print image or other data entered was valid. If the thumb print, finger print or other data input is determined to be invalid in step 1027, an “INVALID THUMB PRINT/IMAGE” message is shown in the display window of the TinyBank apparatus in step 1026 and the method returns to step 923 to await another input. If the thumb print or finger print image or other data entered is determined to be valid in step 1027, a TinyBank Application opens an Encrypted Network Communication and sends a One-Time Passcode in step 1029.

In step 1030 of FIG. 10B, at least one of the finger print, thumb print, smartcard data and handheld device identification is encrypted. Step 1031 sends the encrypted data to the Secure Finger Identification Financial Information System (SFIFI) Server. In step 1032 of FIG. 10B, the SFIFI Server decrypts the encrypted data.

In step 1033, it is determined whether the portable or handheld device identification was valid. If the portable or handheld device identification is determined to be invalid in step 1033, an “INVALID DEVICE” message is shown in the display window of the TinyBank apparatus in step 1034 and the method returns to step 1029. If the portable or handheld device identification is determined to be valid in step 1033, the TinyBank sends a secure/encrypted transaction request message with bank name for a “PAY MERCHANT REQUEST” with a checking account number, mail to address/account and payment amount to the SFIFI server for processing in step 1035.

In step 1037 of FIG. 10B, the SFIFI joins the HHID, TinyBank ID (TINYID), and image data encrypted from TinyBank to create a CAPLET. The SFIFI Server requests the Secure Mulitpurpose Identification Financial Warehouse Storage System (SMIFS) Server communication in steps 1040.

In steps 1039 and 1041 of FIG. 10B, the SFIFI Server sends the CAPLET to the SMIFS Server. The SMIFS Server decrypts the CAPLET in step 1043. In step 1045, the SMIFS Server decrypts stored TinyBank internal and customer records. The SMIFS matches CAPLET data with stored customer identification and TinyBank internal records in step 1046.

In step 1047 of FIG. 10B, the SMIFS Server determines whether the finger print, thumb print, Smartcard Data or handheld device identification is valid. If determined as invalid in step 1047, an “INVALID USER” message is shown in the display window of the TinyBank apparatus in step 1048 and the method returns to step 1023 to await another input. If determined as valid in step 1047, the SMIFS establishes encrypted communications with a bank, financial institution or other secure location in step 1049. In step 1051, the SMIFS sends encrypted transaction number, customer identification “Bill Pay Function codes,” a “BILL PAY” request and an amount to a financial institution or BANK Server.

In step 1053 of FIG. 10B, the Bank Server determines whether the encrypted transaction number, customer identification or other data is valid. If determined as invalid in step 1053, an error message is sent to the SMIFS Sever in step 1056; a “TRANSACTION ERROR” message appears in the display window of the TinyBank apparatus in step 1058; and the method returns to step 1007 to await another input. If determined as valid in step 1053, the bank, financial institution or other secure location processes the “BILL PAY” transaction in step 1055.

In step 1059 of FIG. 10B, the bank application sends a “TRANSACTION COMPLETED” message to the SMIFS Server and closes the session. In step 1061, the SMIFS encrypts data and sends a “TRANSACTION COMPLETED” message to the SFIFI Server and generates a receipt. The SFIFI Server sends a secure/encrypted message to the TinyBank apparatus and/or system is step 1063. In step 1065, the “TRANSACTION COMPLETED” message appears on the display window of the TinyBank apparatus. The communication session with the TinyBank Network is closed in step 1067 and the application returns to the TinyBank Application Menu of step 1007 of FIG. 10A.

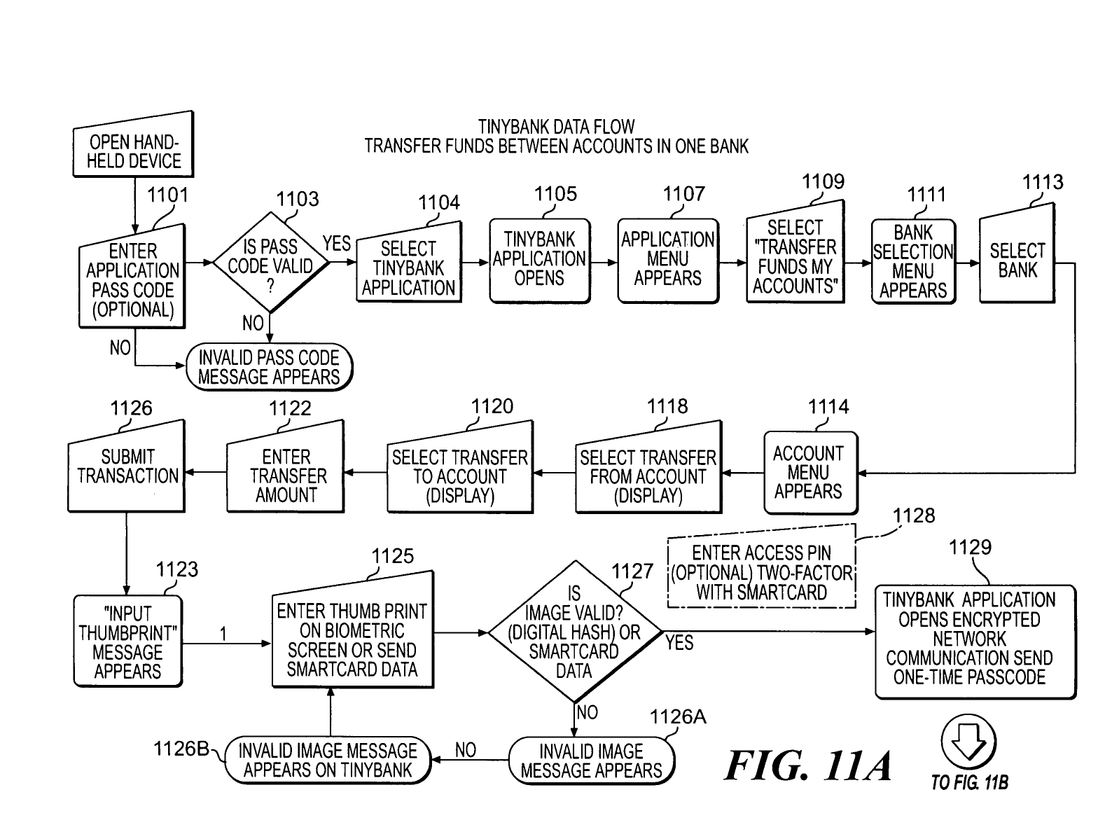

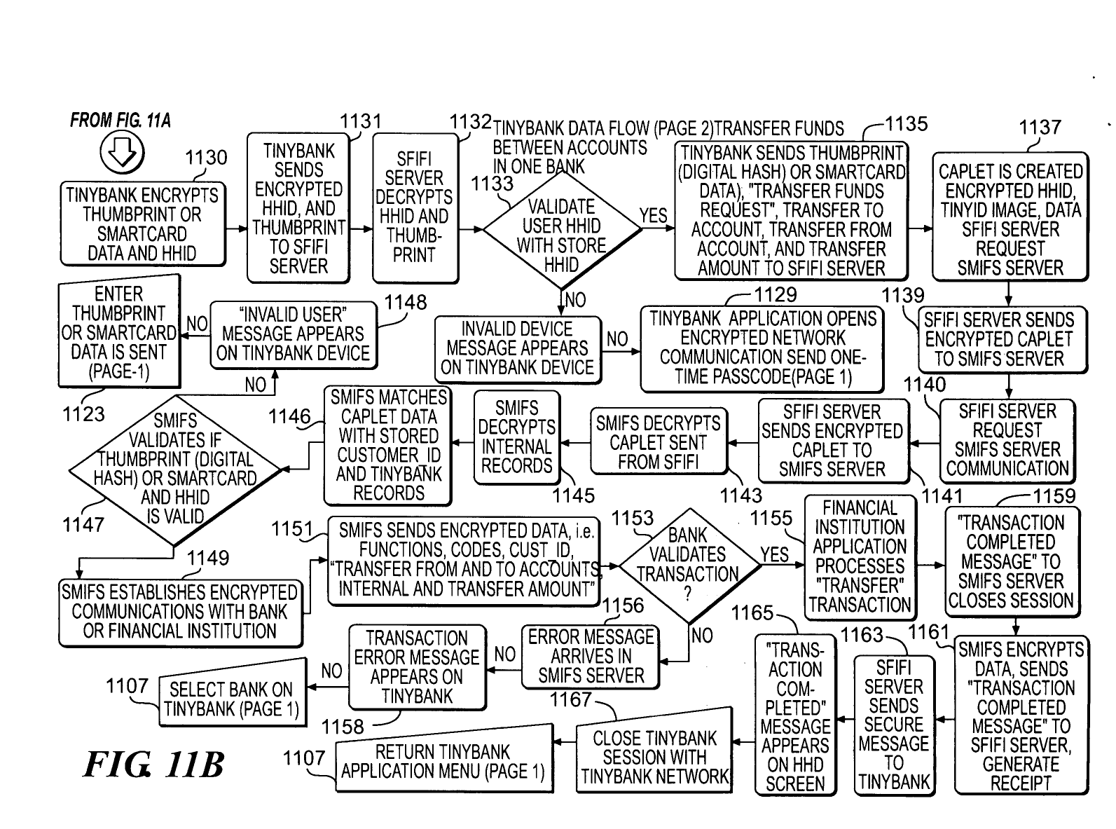

FIG. 11A and FIG. 11B show an exemplary flow diagram for a transfer of funds between accounts in one bank in the present invention. Step 1101 of FIG. 11A involves entering/inputting the application pass code/password. In step 1103, it is determined whether the pass code/pass word was valid. If the pass code/password is determined to be invalid in step 1103, an “INVALID PASS CODE” message is shown in the display window of the TinyBank apparatus and the method returns to step 1101 to await a pass code/password input. If the pass code/password is determined to be valid in step 1103, a TinyBank application is selected and opens on the TinyBank apparatus in step 1104 and step 1105, respectively; and an Application Menu opens on the display of the display window in step 1107.

In step 1109 of FIG. 11A, the “TRANSFER FUNDS MY ACCOUNT” option is selected from the Application Menu and a Bank Selection Menu appears in step 1111. Step 1113 selects a bank. In step 1114 an Account Menu appears on the display of the TinyBank apparatus. A selection is made for “TRANSFER FROM” and “TRANSFER TO” from the Account Menu is steps 1118 and 1120, respectively. An amount to transfer is entered in step 1122 and the transaction is submitted in step 1126.

In FIG. 11A, step 1123 provides an “INPUT THUMB PRINT” message on the display window of the TinyBank apparatus. In step 1125, the customer enters at least one of a thumb or finger print on the input screen, or embedded SmartCard data into the TinyBank apparatus. Alternatively, one may enter an optional access PIN and TWO-Factor with Smartcard in step 1128. In step 1127, it is determined whether the thumb print, finger print image or other data entered was valid. If the thumb print, finger print or other data input is determined to be invalid in step 1127, an “INVALID THUMB PRINT/IMAGE” message is generated in step 1126A and shown in the display window of the TinyBank apparatus in step 1126B and the method returns to step 1125 to await another input. If the thumb print or finger print image or other data entered is determined to be valid in step 1127, a TinyBank Application opens an Encrypted Network Communication and sends a One-Time Passcode in step 1129.

In step 1130 of FIG. 11B, at least one of the finger print, thumb print, smartcard data and handheld device identification is encrypted. Step 1131 sends the encrypted data to the Secure Finger Identification Financial Information System (SFIFI) Server. In step 1132 of FIG. 11B, the SFIFI Server decrypts the encrypted data.

In step 1133, it is determined whether the portable or handheld device identification was valid. If the portable or handheld device identification is determined to be invalid in step 1133, an “INVALID DEVICE” message is shown in the display window of the TinyBank apparatus in step 1134 and the method returns to step 1129. If the portable or handheld device identification is determined to be valid in step 1133, the TinyBank sends a secure/encrypted transaction request message with bank name for a “TRANFER FUNDS MY ACCOUNT” request with a transfer from, transfer to account, and transfer payment amount to the SFIFI server for processing in step 1135.

In step 1137 of FIG. 11B, the SFIFI joins the HHID, TinyBank ID (TINYID), and image data encrypted from TinyBank to create a CAPLET. The SFIFI Server requests the Secure Mulitpurpose Identification Financial Warehouse Storage System (SMIFS) Server communication in steps 1140.

In steps 1139 and 1141 of FIG. 11B, the SFIFI Server sends the CAPLET to the SMIFS Server. The SMIFS Server decrypts the CAPLET in step 1143. In step 1145, the SMIFS Server decrypts stored TinyBank internal and customer records. The SMIFS matches CAPLET data with stored customer identification and TinyBank internal records in step 1146.

In step 1147 of FIG. 11B, the SMIFS Server determines whether the finger print, thumb print, Smartcard Data or handheld device identification is valid. If determined as invalid in step 1147, an “INVALID USER” message is shown in the display window of the TinyBank apparatus in step 1148 and the method returns to step 1123 to await another input. If determined as valid in step 1147, the SMIFS establishes encrypted communications with a bank, financial institution or other secure location in step 1149. In step 1151, the SMIFS sends encrypted transaction number, customer identification “Transfer Function codes,” a “TRANSFER FUNDS” request, transfer from account transfer to account and an amount to transfer to a financial institution or BANK Server.

In step 1153 of FIG. 11B, the Bank Server determines whether the encrypted transaction number, customer identification or other data is valid. If determined as invalid in step 1153, an error message is sent to the SMIFS Sever in step 1156; a “TRANSACTION ERROR” message appears in the display window of the TinyBank apparatus in step 1158; and the method returns to step 1107 to await another input. If determined as valid in step 1153, the bank, financial institution or other secure location processes the “TRANSFER FUNDS” transaction in step 1155.

In step 1159 of FIG. 11B, the bank application sends a “TRANSACTION COMPLETED” message to the SMIFS Server and closes the session. In step 1161, the SMIFS encrypts data and sends a “TRANSACTION COMPLETED” message to the SFIFI Server and generates a receipt. The SFIFI Server sends a secure/encrypted message to the TinyBank apparatus and/or system is step 1163. In step 1165, the “TRANSACTION COMPLETED” message appears on the display window of the TinyBank apparatus. The communication session with the TinyBank Network is closed in step 1167 and the application returns to the TinyBank Application Menu of step 1107 of FIG. 11A.

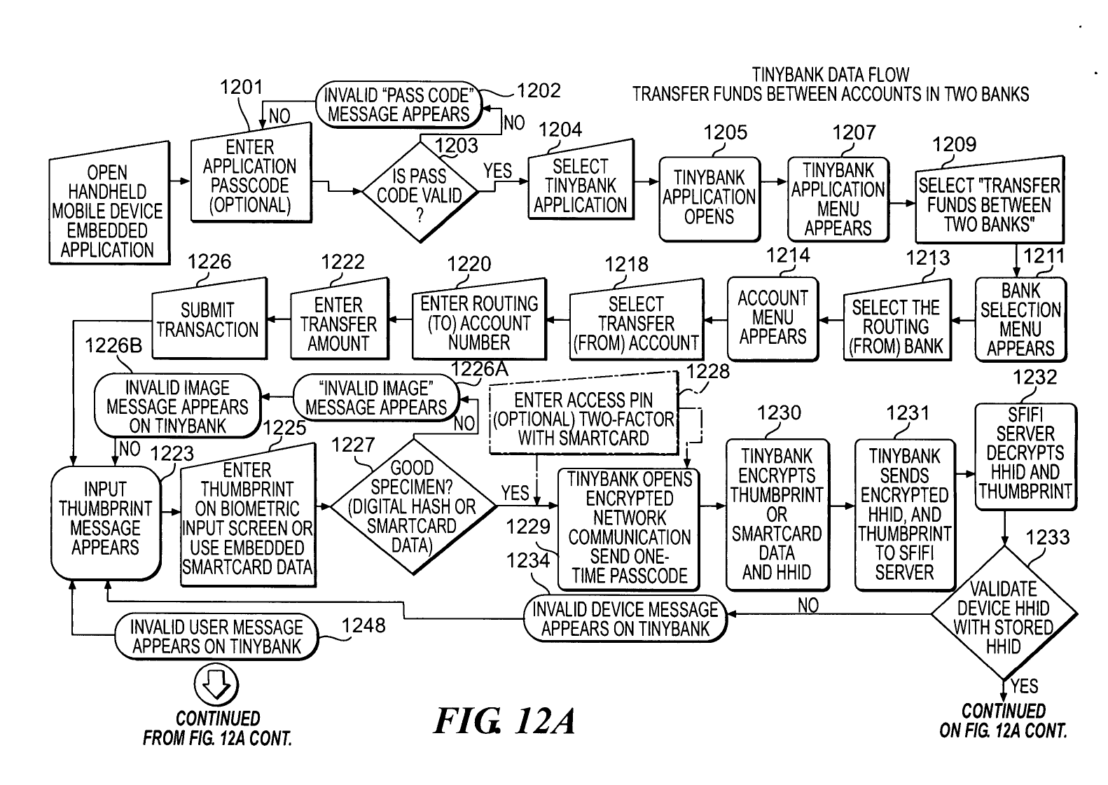

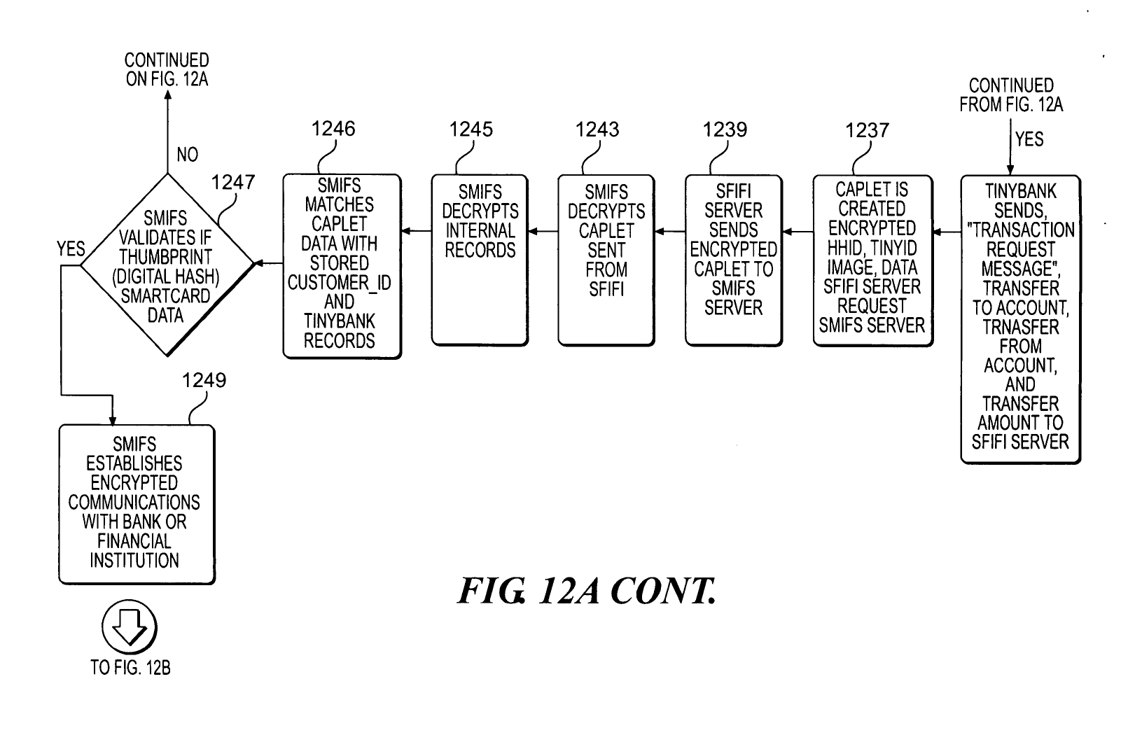

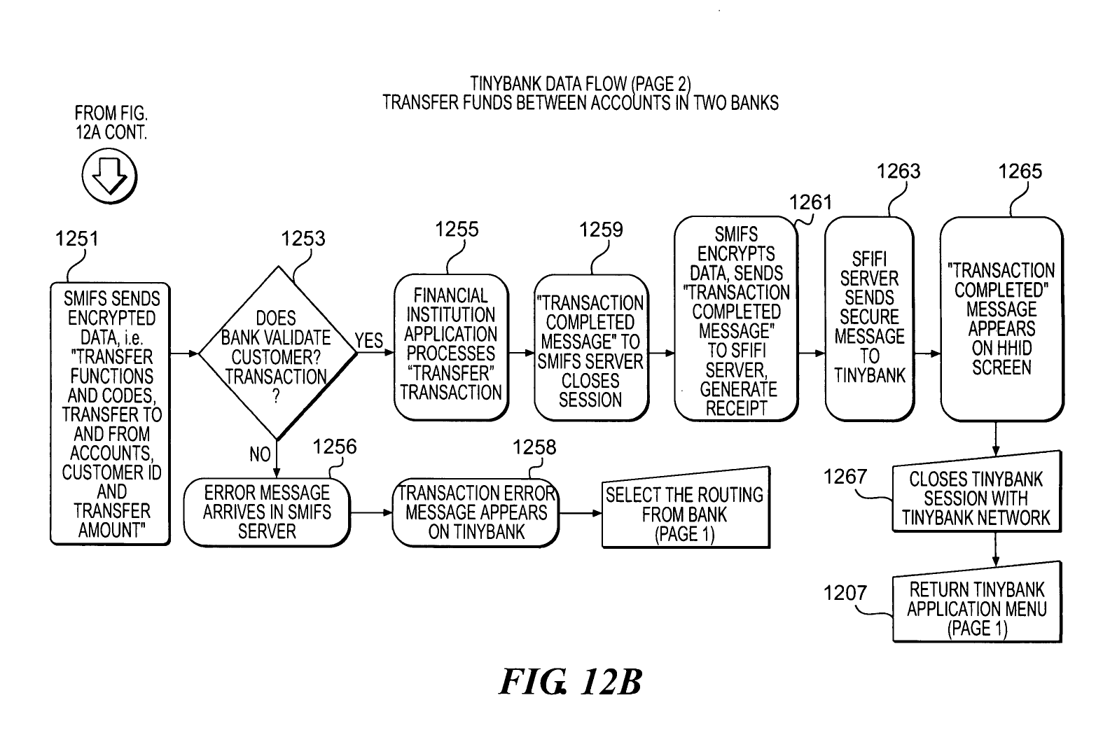

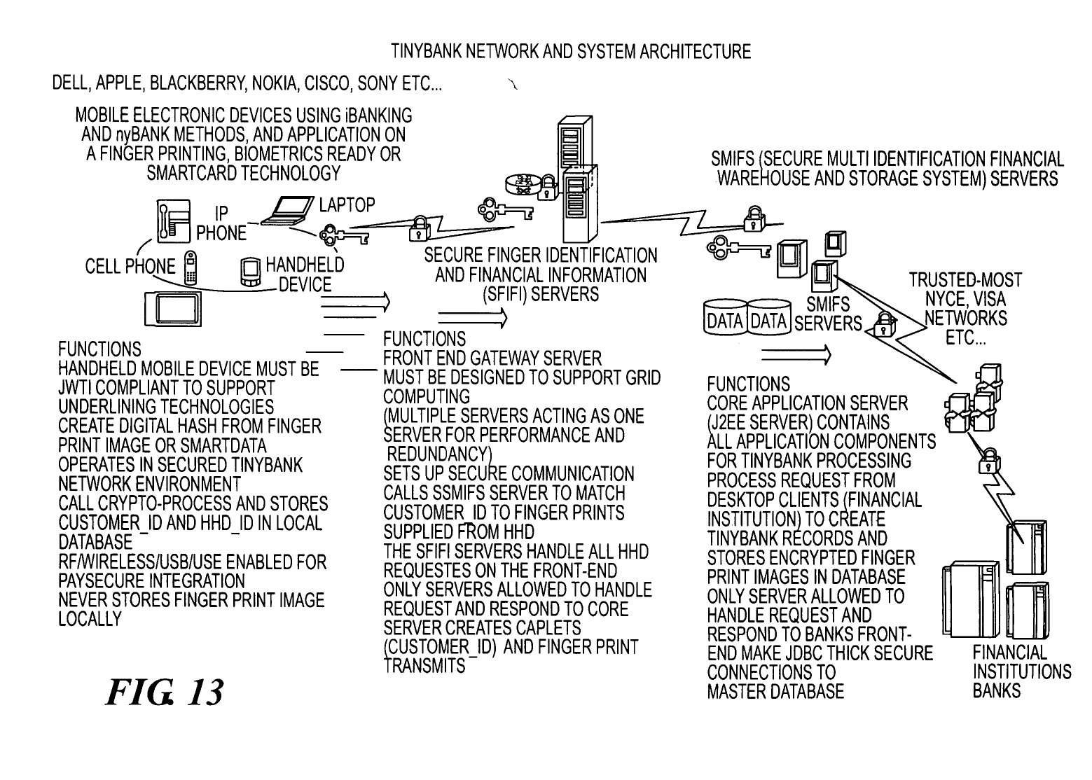

FIG. 12A and FIG. 12B show exemplary flow diagrams for a transfer of funds between accounts in two bank in the present invention. Step 1201 of FIG. 12A involves entering/inputting the application pass code/password. In step 1203, it is determined whether the pass code/pass word was valid. If the pass code/password is determined to be invalid in step 1203, an “INVALID PASS CODE” message is shown in the display window of the TinyBank apparatus and the method returns to step 1201 to await a pass code/password input. If the pass code/password is determined to be valid in step 1203, a TinyBank application is selected and opens on the TinyBank apparatus in step 1204 and step 1205, respectively; and an Application Menu opens on the display of the display window in step 1207.

In step 1209 of FIG. 12A, the “TRANSFER FUNDS BETWEEN TWO ACCOUNTS” option is selected from the Application Menu and a Bank Selection Menu appears in step 1211. Step 1213 selects a routing bank. In step 1214 an Account Menu appears on the display of the TinyBank apparatus. A selection is made for “TRANSFER FROM” and “TRANSFER TO” from the Account Menu is steps 1218 and 1220, respectively. An amount to transfer is entered in step 1222 and the transaction is submitted in step 1226.

In FIG. 12A, step 1223 provides an “INPUT THUMB PRINT” message on the display window of the TinyBank apparatus. In step 1225, the customer enters at least one of a thumb or finger print on the input screen, or embedded SmartCard data into the TinyBank apparatus. Alternatively, one may enter an optional access PIN and TWO-Factor with Smartcard in step 1228. In step 1227, it is determined whether the thumb print, finger print image or other data entered was valid. If the thumb print, finger print or other data input is determined to be invalid in step 1227, an “INVALID THUMB PRINT/IMAGE” message is generated in step 1226A and shown in the display window of the TinyBank apparatus in step 1226B and the method returns to step 1225 to await another input. If the thumb print or finger print image or other data entered is determined to be valid in step 1227, a TinyBank Application opens an Encrypted Network Communication and sends a One-Time Passcode in step 1229.

In step 1230 of FIG. 12A, at least one of the finger print, thumb print, smartcard data and handheld device identification is encrypted. Step 1231 sends the encrypted data to the Secure Finger Identification Financial Information System (SFIFI) Server. In step 1232 of FIG. 12A, the SFIFI Server decrypts the encrypted data.

In step 1233, it is determined whether the portable or handheld device identification was valid. If the portable or handheld device identification is determined to be invalid in step 1233, an “INVALID DEVICE” message is shown in the display window of the TinyBank apparatus in step 1234 and the method returns to step 1229. If the portable or handheld device identification is determined to be valid in step 1233, the TinyBank sends a secure/encrypted transaction request message with bank name for a “TRANFER FUNDS BETWEEN TWO ACCOUNTS” with a transfer from, transfer to account, and transfer payment amount to the SFIFI server for processing in step 1235.

In step 1237 of FIG. 12A, the SFIFI joins the HHID, TinyBank ID (TINYID), and image data encrypted from TinyBank to create a CAPLET. The SFIFI Server requests the Secure Mulitpurpose Identification Financial Warehouse Storage System (SMIFS) Server communication in steps 1240.

In steps 1239 and 1241 of FIG. 12A, the SFIFI Server sends the CAPLET to the SMIFS Server. The SMIFS Server decrypts the CAPLET in step 1243. In step 1245, the SMIFS Server decrypts stored TinyBank internal and customer records. The SMIFS matches CAPLET data with stored customer identification and TinyBank internal records in step 1246.

In step 1247 of FIG. 12A, the SMIFS Server determines whether the finger print, thumb print, Smartcard Data or handheld device identification is valid. If determined as invalid in step 1247, an “INVALID USER” message is shown in the display window of the TinyBank apparatus in step 1148 and the method returns to step 1223 to await another input. If determined as valid in step 1247, the SMIFS establishes encrypted communications with a bank, financial institution or other secure location in step 1249. In step 1151 of FIG. 12B, the SMIFS sends encrypted transaction number, customer identification “Transfer Function codes,” a “TRANSFER FUNDS BETWEEN TWO BANKS” request, transfer from account transfer to account and an amount to transfer to a financial institution or BANK Server.

In step 1253 of FIG. 12B, the Bank Server determines whether the encrypted transaction number, customer identification or other data is valid. If determined as invalid in step 1253, an error message is sent to the SMIFS Sever in step 1256; a “TRANSACTION ERROR” message appears in the display window of the TinyBank apparatus in step 1258; and the method returns to step 1207 to await another input. If determined as valid in step 1253, the bank, financial institution or other secure location processes the “TRANSFER FUNDS BETWEEN TWO ACCOUNTS” transaction in step 1255.

In step 1259 of FIG. 12B, the bank application sends a “TRANSACTION COMPLETED” message to the SMIFS Server and closes the session. In step 1261, the SMIFS encrypts data and sends a “TRANSACTION COMPLETED” message to the SFIFI Server and generates a receipt. The SFIFI Server sends a secure/encrypted message to the TinyBank apparatus and/or system is step 1263. In step 1265, the “TRANSACTION COMPLETED” message appears on the display window of the TinyBank apparatus. The communication session with the TinyBank Network is closed in step 1267 and the application returns to the TinyBank Application Menu of step 1207 of FIG. 12A.

The foregoing description of the invention illustrates and describes the present invention. Additionally, the disclosure shows and describes only the preferred embodiments of the invention in the context of a method for increasing the yield of programmable logic devices, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described herein above are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

What is claimed as new and desired to be protected by Letters Patent of the United States is:

1. An apparatus configured for accessing secure information, comprising:
a numeric keypad;
an alphabetic keypad;
a cursor control keypad;
a display window;
an input window;
a first communication port; and
a second communication port,
wherein the numeric and alphabetic keypads are configured for data input, the input window is configured for at least one of finger print, thumb print and biometric data for identification purpose for secure communication; the cursor control pad is configured for navigating selection menus provided on the display window.

2. The apparatus of claim 1, wherein the input window is a biometric sensor.

3. The apparatus of claim 1, wherein the first communication port is at least one of wired and wireless.

4. The apparatus of claim 1, wherein the first communication port utilizes at least one of cable, fiber optics and telephone lines.

5. The apparatus of claim 1, wherein the second communication port utilizes at least one of radio waves, microwaves, infrared, lasers and light-emitting diodes.

6. The apparatus of claim 1, wherein the second communication port utilizes at least one of USB, Bluetooth and IEEE-1394 and RS-232.

7. The apparatus of claim 6, wherein an external biometric sensor is connect to the second communication port.

8. A system for accessing secure information, comprising:
a portable device configured with a biometric interface and to provide secure access;
a Secure Finger Identification Financial Information (SFIFI) Server configured create CAPLETS;
a SFIFI server database configured to at least store portable device identification numbers;
a Multi-Identification Financial System (MIFS) Server configured to create records and store user records; and
a Secure Multi-Identification Financial System (SMIFS) Server configured to store encrypted figner print images in a database.

9. A method for secure access, comprising:
inputting a pass code/password for local verification;
verify the pass code/password was valid;
opening an embedded device application when the password is valid;
providing a display menu for the embedded application with program selection options;
selecting an application program option;
requesting a biometric data in order to obtain secure access;
encrypting the biometric data;
determining whether the encryption was successful;
opening communications with secure network servers when the encryption is successful.
